(19) United States
(12) Patent Application Publication
(10) Pub. No.: US 2023/0017986 A1
(43) Pub. Date: Jan. 19, 2023

(54) TIRE CHANGER

(71) Applicant: Snap-on Equipment Srl a unico socio, Correggio (IT)

(72) Inventor: Paolo SOTGIU, Modena (IT)

(73) Assignee: Snap-on Equipment Srl a unico socio, Correggio (IT)

(21) Appl. No.: 17/865,924

(22) Filed: Jul. 15, 2022

(30) Foreign Application Priority Data
Jul. 16, 2021 (IT) 102021000018722

(51) Int. Cl. B60C 25/05; B60C 25/138

(52) U.S. Cl. CPC B60C 25/0554; B60C 25/138

(57) ABSTRACT

Apparatus and method for mounting a tire on a rim of a wheel and/or for removing a tire from a rim of a wheel of a vehicle. This apparatus is generally known as a tire changer. The tire changer of the present invention uses contactless sensors, in particular radar sensors, to scan the geometric dimensions of the wheel to be maintained and, in general, to accurately control the mounting/demounting tools.

### FIELD OF THE INVENTION

The present invention relates to an apparatus for mounting a tire on a rim of a wheel and/or for removing a tire from a rim of a wheel of a vehicle, generally known as a tire changer. Also included within the scope of the present invention is a method for mounting a tire on a rim of a wheel and/or for removing a tire from a rim of a wheel of a vehicle, which can be performed by means of a tire changer according to the present invention.

### PRIOR ART

The wheels of vehicles are generally composed of a rim and a tire mounted on it. Tire changers are generally used in car repair workshops in order to remove the tires from the rims and/or to mount said tires on respective rims.

Before a tire can be removed from a rim it is necessary to perform what is referred to as bead breaking of the tire, in other words completely separate both beads of the tire from the rim, using a special bead breaker tool. Only after this operation is it possible to then proceed with the actual operation of removing the tire from the rim, generally using suitable mounting/demounting tools.

There are various types of bead breaker tools, for example of the blade or paddle type, roller type, disk type, etc. Disk tools are particularly widespread on more efficient and modern tire changers. These disk-type bead breaker tools usually comprise a rotatable disk which, sometimes, but not always, has a frustoconical shape and is mounted idle on a support arm. The disk of the bead breaker tool, or bead breaker disk, is placed in contact with the sidewall of the tire of a wheel secured to a rotary support. When the support rotates, the wheel, which is rigidly secured thereto, will also start to rotate, allowing the bead breaker tool to operate on the tire over an entire circumferential revolution and therefore separate completely the bead of the tire from the rim.

In order to successfully complete a bead breaking operation in a short time and without damaging either the sidewall of the tire, the wheel rim or the bead breaker tool itself, it is important to correctly position the tool both relative to the rim and relative to the tire.

In particular, with the wheel stationary, deflated and mounted on the support, the bead breaker disk is brought up to the edge of the rim, usually however without touching the rim but instead making contact with the sidewall of the tire.

In order to perform the actual bead breaking process, the bead breaker disk is preferably moved and advanced—sometimes pivoted—toward the axis of rotation of the wheel, so as to be inserted between the edge of the rim (sometimes, however, touching it) and the tire, thereby starting the gradual separation of the bead of the tire from the rim, rotation of the tire-bearing wheel being started in the meantime.

In order to complete the bead breaking process, it is then usually necessary, during the process itself, to move the bead breaker tool also parallel to the axis of rotation of the wheel, preferably with the tire-bearing wheel still rotating, so as to allow the bead breaker disk to interact better with the sidewall of the tire and/or with the rim channel.

Overall, the movement of the bead breaker tool may be defined as being a trajectory comprising sections involving an advancing movement both in a direction substantially parallel to the axis of rotation of the wheel and in a direction substantially perpendicular to the axis of rotation of the wheel, all of this both toward and if necessary away from the wheel.

Once the bead breaking process has been completed and both beads have been separated, the tire may be completely removed from the rim, usually with the aid of further demounting tools, such as levers, hooks, etc.

Sometimes, the demounting tools are combined with respective mounting tools, or special mounting/demounting tools may be provided, i.e. tools which may perform both the mounting and demounting functions.

These mounting and/or demounting tools, which are often mounted pivotably in more modern and efficient tire changers, must be moved accurately toward and away from the axis of rotation of the wheel, so as to interact better with the sidewall of the tire and/or with the rim channel.

During both demounting and mounting, the movement trajectory of these tools generally comprises sections involving an advancing movement both in a direction substantially parallel to the axis of rotation of the wheel and in a direction substantially perpendicular to the axis of rotation of the wheel, all of this both toward and if necessary away from the wheel.

As mentioned, if this not performed properly, both the bead breaking process and the subsequent tire removal process may not be effective or may not result in complete separation of the tire beads from the rim or may result in damage to the tire, rim or both of them.

Likewise, when mounting a tire on a respective rim, the mounting tool must be positioned precisely relative to the rim, so as to help ensure that the tire is inserted correctly inside the edges of the rim.

In general, it is therefore important to be able to correctly position and move the mounting/demounting, bead breaker, etc. tools, relative to the rim of the wheel and/or relative to the tire, both during the mounting operations and during the demounting operations.

Over time, various solutions have been proposed for helping the operator of a tire changer to correctly position and move the tools with respect to the wheel, both in the case of bead breaker tools and in the case of mounting and/or demounting tools.

These solutions generally involve the use of sensors of various types that can detect the position of the tools and/or the wheel or components of the wheel, which can then be moved automatically thanks to special actuators or, at least partially, with the intervention of an operator. The degree of automation and efficiency of the mounting and/or demounting process, which is generally based on the combined use of sensors and actuators, may thus vary quite widely, according to the different solutions proposed, which use sensors and actuators with different characteristics and levels of performance.

For example, EP1584495A2 discloses a tire changer having a disk-type bead breaker tool, combined with a sensor pin that can detect the presence of the wheel coming into contact with the edge or flange of the rim or with the sidewall of the tire.

EP2484541A1 discloses a tire changer having a disk-type bead breaker tool that can move in a direction parallel to the axis of rotation of the wheel, and has a control unit that can detect the advancing speed curve of the tool in said direction.

EP3722114A1 discloses a tire changer having a bead breaker tool comprising a support element and a bead breaker disk, said bead breaker tool further comprising a sensor able to cause a relative rotation of the support element and the bead breaker disk.

EP1927484A1 discloses a tire changer having optical sensors for identifying the edge of the rim, and automatically moving the mounting/demounting tool.

EP2110270A1 discloses a tire changer having tools, both bead breaker and mounting/demounting tools, that can move, by virtue of actuator means, parallel to the axis of rotation of the wheel and the movement of which in said direction is monitored by a specific sensor. In the solution described by EP2110270A1, the wheel is moved in a direction perpendicular to its axis of rotation, toward and/or away from the tools.

EP2347919A1 discloses a tire changer comprising a vision system having video cameras, for detecting the relative positions of the wheel and tools.

EP2332749A1 discloses a tire changer comprising a vision system, having laser sensors referred to as light section sensors, for determining the geometric dimensions of the wheel.

However, the known solutions may be further improved in terms of reliability, safety, precision and ease of use.

### OBJECT OF THE INVENTION

In this regard, the Applicant aims to propose a tire changer, and a related method for mounting a tire on a rim and/or for removing a tire from a rim of a vehicle wheel which is, compared to the prior art, of a more simple design, reliable, robust, accurate and easy to maintain.

Another aim of the present invention is to provide a tire changer, and a related method for mounting/demounting a tire on/from a rim, which makes use of sensors for determining the relative positions of the wheel, or components of the wheel, and the tools, which ensures speedy and correct operation, without errors due, for example, to the characteristics of the sensor used, in relation to the speed at which maintenance is performed and/or to the environmental conditions in which the sensor is used.

Another aim of the present invention is to provide a tire changer, and a related method for mounting/demounting a tire on/from a rim, which minimizes the time required for processing of the scanning signal from the sensor and/or any latency which can have a negative effect on the control of the devices for actuating the automatic movement of the tools.

Another aim of the present invention is to provide a tire changer, and a related method for mounting/demounting a tire on/from a rim, which eliminates sensor exposure times, typical, for example, in the case of optical sensors.

Another aim of the present invention is to provide a tire changer, and a related method for mounting/demounting a tire on/from a rim, which eliminates the need for physical contact between the sensor and the wheel, typical, for example, in the case of mechanical contact sensors.

In general, it is an aim of the present invention to provide a tire changer, and a related method for mounting/demounting a tire on/from a rim which allows optimal control of the actuators for moving the tools and/or the wheel, according to the geometric dimensions of the wheel and/or the relative positions between the wheel and the tools, detected by special contactless sensors.

These and other aims of the present invention will be obvious to those skilled in the art from reading the present detailed description and from the attached illustrative drawings.

### SUMMARY OF THE INVENTION

The Applicant has found that these and further aims are achieved by an apparatus for demounting a tire from a rim of a vehicle wheel and/or for mounting a tire on a rim of a vehicle wheel, for example a tire changer, comprising a rotary support element to which the rim of the wheel is reversibly secured, and having motor means, for example an electric motor, for rotating the rotary support element.

The apparatus according to the invention further comprises at least one mounting and/or demounting tool for mounting the tire on the rim and/or for demounting the tire from the rim, and at least one contactless sensor device, for detecting a distance, with respect to a reference position, of at least one point belonging to the wheel.

The apparatus comprises sensor means for detecting the position of the at least one mounting and/or demounting tool relative to the reference position and a control unit for correlating the position of the at least one mounting and/or demounting tool with the distance of the at least one point belonging to the wheel, relative to the reference position.

The apparatus further comprises at least one actuator, guided by the control unit, for moving the at least one mounting and/or demounting tool as a function of the distance of the at least one point belonging to the wheel with respect to the reference position, and is characterized in that the at least one sensor device comprises a radar system.

In other words, the control unit can act in real time on the actuator used for moving the at least one mounting/demounting tool, on the basis of the scanning data supplied by the at least one sensor device.

According to one embodiment, the radar system operates at frequencies between 300 MHz and 300 GHz.

According to one embodiment, the radar system is a millimeter-wave radar system and operates at frequencies between 30 GHz and 300 GHz. According to a preferred embodiment, the millimeter-wave radar system operates at frequencies between 76 GHz and 81 GHz.

According to one aspect, the reference position is fixed relative to the structure of the base and/or of the frame of the tire changer.

According to one aspect, the reference position is integral with the contactless sensor device.

According to one aspect, the reference position is integral with the at least one mounting and/or demounting tool or with a support structure thereof.

According to one aspect, the reference position is integral with a point belonging to the axis of rotation of the wheel or is in any case located close to the axis of rotation of the wheel.

According to one embodiment, the at least one mounting/demounting tool is moved, toward and/or away, relative to the wheel.

According to one embodiment, the wheel is moved in a direction perpendicular to its axis of rotation, toward and/or away, relative to the at least one mounting/demounting tool.

According to one embodiment, the at least one mounting/demounting tool is moved, toward and/or away, relative to the wheel and at the same time the wheel is moved in a direction perpendicular to its axis of rotation, toward and/or away, relative to the at least one mounting/demounting tool.

According to one possible embodiment, the sensor means for detecting the position of the at least one mounting and/or demounting tool relative to the reference position comprise a radar system, for example a millimeter-wave radar system, preferably of the same type as the contactless sensor device used for detecting the distance, relative to the reference position, of at least one point belonging to the wheel.

According to one embodiment, the at least one contactless sensor device can detect the distance, with respect to the reference position, of a plurality of points belonging to the wheel, preferably belonging to an outer contour of the rim of the wheel.

According to one embodiment, the at least one contactless sensor device can detect the distance, with respect to the reference position, of at least one point belonging to the tire of the wheel, preferably belonging to the sidewall of the tire of the wheel.

According to one embodiment, the tire changer of the present invention comprises a plurality of mounting/demounting tools.

According to one aspect, said plurality of mounting/demounting tools comprises at least one bead breaker tool.

According to one embodiment, the control unit with which the tire changer of the present invention is provided, is connected to memory means for storing, at least temporarily, data relating to geometric characteristics of the wheel.

According to one aspect, said memory means are located on the tire changer.

According to one aspect, said memory means are located on a remote computer system, for example on a cloud.

According to one embodiment, the remote computer system comprises a database comprising data relating to geometric characteristics of wheels, which is constantly updated by tire changers according to the present invention.

The present invention also relates to a method for demounting a tire from a rim of a vehicle wheel or for mounting a tire on a rim of a vehicle wheel, comprising the steps of securing the rim of the wheel to a rotary support element, and of detecting a distance, with respect to a reference position, of at least one point belonging to the wheel by means of at least one contactless sensor device.

The method of the present invention further comprises the steps of detecting the position of at least one mounting and/or demounting tool relative to the reference position, of correlating the position of the at least one mounting and/or demounting tool with the distance of the at least one point belonging to the wheel, relative to the reference position, and of moving, during the operation of mounting the tire on the rim and/or demounting the tire from the rim, the at least one mounting and/or demounting tool as a function of the distance of the at least one point belonging to the wheel with respect to the reference position. The method of the present invention is characterized in that the at least one contactless sensor device comprises a radar system.

According to one embodiment, the method of the present invention uses a radar system which operates at frequencies between 300 MHz and 300 GHz.

According to one embodiment, the method of the present invention uses a millimeter-wave radar system which operates at frequencies between 30 GHz and 300 GHz. According to a preferred embodiment, the millimeter-wave radar system operates at frequencies between 76 GHz and 81 GHz.

Below, by way of example and therefore in a non-limiting manner, a number of preferred embodiments of the present invention will be described.

### BRIEF DESCRIPTION OF THE DRAWINGS

This description will be provided hereinbelow with reference to the attached drawings which are provided solely by way of non-limiting example and in which:

FIG. 1 is an axonometric view of an example of a tire changer according to the invention;

FIG. 2 schematically shows a tool of the tire changer of FIG. 1, according to one possible embodiment.

### DETAILED DESCRIPTION OF PREFERRED EMBODIMENTS OF THE INVENTION

In the description below, any expressions used, such as “right-hand”, “left-hand”, “above”, “below”, “upper”, “lower”, “horizontal”, “vertical” and the like, are used merely for illustrative purposes and refer to the particular arrangement of the elements present in the attached figures and therefore are not limiting in any way.

With reference to the attached figures, 1 denotes overall an apparatus for maintaining vehicle wheels, in particular a tire changer.

The tire changer 1 comprises a base 100 on which there is mounted a rotary wheel support assembly, referred to in short as “support 110”, preferably of the plate type, on which a wheel R comprising a rim C and, possibly, a tire P is reversibly clamped using suitable clamping means known per se.

The base 100 has, joined thereto, a frame 200 having an upright 210 extending mainly at right angles with respect to the support surface of the base. In the figure, the upright 210 extends vertically with respect to the horizontal surface on which the base 100 rests. However, the present invention also comprises the possible configuration where the upright 210 extends mainly parallel to the support surface of the base, this being frequently the case of tire changers intended for the wheels of heavy vehicles.

The longitudinal axis L of the upright 210 is therefore, in any case, substantially parallel to the axis of rotation A of the wheel R which is clamped on the support 110, both in the case where this axis of rotation A is vertical and in the case where it is horizontal.

The upright 210 has, associated with it, a support arm 300 movable along the longitudinal axis L, namely in a direction substantially parallel to the axis of rotation A of the wheel R.

The support arm 300 is composed of a first element 301 that can slide in the longitudinal direction L of the upright 210 and a second element 302 which is coupled to the first element 301 and inside which a component or arm-piece 303 can slide, the longitudinal axis X of the latter being substantially parallel to the horizontal support surface of the base 100 and it can therefore move in a direction substantially perpendicular to the axis of rotation of the wheel.

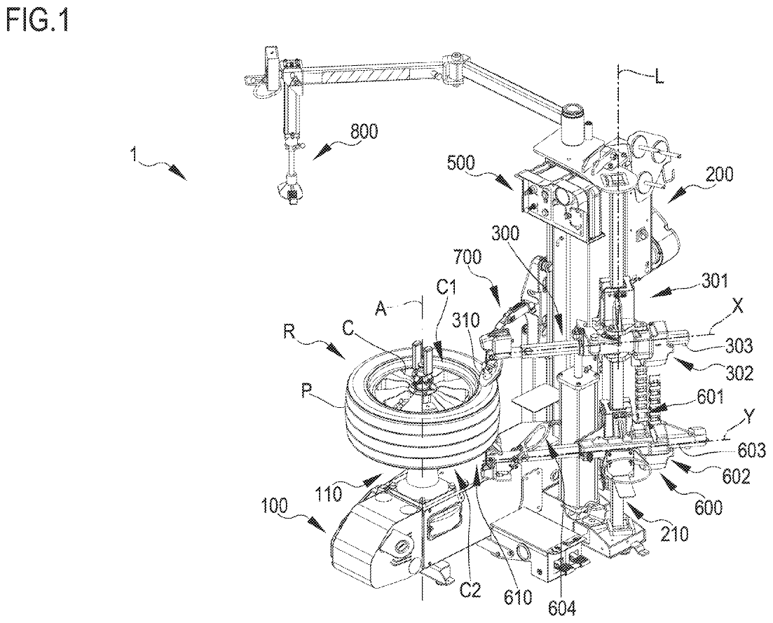

A tool, in the particular case of FIG. 1 a bead breaker disk 310, is mounted pivotably on one end of the support arm 300, in particular on one end of the arm-piece 303.

The embodiments shown in the attached figures therefore refer to pivoting tools, the movement trajectories thereof therefore comprising at least one oscillation of the tool relative to the respective support arms or their components; however, the present invention must be understood as being applicable also in the case where the tools are not of the pivoting type and the movement trajectories of the tools do not comprise any oscillation relative to the respective support arms.

The bead breaker disk 310 is mounted idle on the support arm 300 and is designed to operate on the wheel R in the vicinity of a first edge C1, or upper edge, of the rim C. In other words, the bead breaker disk 310 is designed to operate on the first bead, or upper bead, of the tire P.

The tire changer according to FIG. 1 also comprises a second support arm 600, which is also movable along the longitudinal axis L, namely in a direction substantially parallel to the axis of rotation A of the wheel R.

The second support arm 600 comprises a first element 601 that can slide in the longitudinal direction L of the upright 210 and a second element 602 which is coupled to the first element 601 and inside which a component or arm-piece 603 can slide, the longitudinal axis Y of the latter being substantially parallel to the horizontal support surface of the base 100 and it can therefore move in a direction substantially perpendicular to the axis of rotation of the wheel.

A tool, in the particular case of FIG. 1 a bead breaker disk 610, is mounted pivotably on one end of the support arm 600, in particular on one end of the arm-piece 603.

The bead breaker disk 610 is mounted idle on the support arm 600 and is designed to operate on the wheel R in the vicinity of a second edge C2, or lower edge, of the rim C. In other words, the bead breaker disk 610 is designed to operate on the second bead, or lower bead, of the tire P.

In the rest of the present description, reference will be made mainly to the support arm 300 carrying the bead breaker disk 310 designed to operate on the upper bead of the tire P. However, the functions of the second support arm 600 and of the associated bead breaker disk 610 designed to operate on the lower bead of the tire P are entirely similar and, therefore, for the sake of conciseness, the description provided in relation to the first support arm will not be repeated for said second support arm 600. In fact, in general the sole difference presented by the second support arm 600 is that it comprises, in addition to the bead breaker disk 610, a further pivoting tool 604 designed to facilitate the mounting of the lower bead, this further pivoting tool 604 being known per se, for example from the patent EP2949487A1.

In the description below, the further pivoting tool 604 will not be described in detail. However, the present invention, which will instead be described in detail in relation to the bead breaker tool 310, must be clearly understood as being applicable also to the further pivoting tool 604.

The tire changer shown in FIG. 1 further comprises a mounting/demounting tool 700, for example but not necessarily pivoting, for mounting the tire P on the rim and/or for removing, once the bead breaking operation has been completed, the tire P from the rim C.

In the description below, the pivoting mounting/demounting tool 700 will not be described in detail. However, the present invention, which will instead be described in detail in relation to the bead breaker tool 310, must be clearly understood as being applicable also to the pivoting mounting/demounting tool 700.

The tire changer shown in the figures also comprises an auxiliary tool 800, known per se, designed to facilitate the mounting and demounting operations.

In the description below, the auxiliary tool 800 will not be described in detail. However, the present invention, which will instead be described in detail in relation to the bead breaker tool 310, must be clearly understood as being applicable also to the auxiliary tool 800.

Moreover, as mentioned above, the present invention must be understood as being applicable also in the case where the bead breaker tools 310, 610 or the mounting/demounting tool 700 are not of the pivoting type.

In the attached figures, the mounting/demounting tool 700 is not provided with actuators for controlling pivoting thereof, while the bead breaker disks 310, 610 are provided with specific pneumatic actuators mounted on the respective arm-piece 303, 603 and designed to cause pivoting thereof. The present invention must therefore be understood as being applicable, for any type of tool, also in the case where said actuators mounted on the support arms are not present and/or are replaced by any mechanical devices such as cams, springs, hinged mechanisms, and the like, and the movement of the tools is caused solely by the vertical movement of the respective support arms, in general controlled by means of actuators.

Similarly, in the description below, the support assembly 110 is mounted fixed with respect to the base 100; however, the present invention must be understood as being applicable also to the case where the support 110 is mounted in such a way as to be movable with respect to the base, in particular toward and/or away from the upright 210 of the frame 200, or the tools.

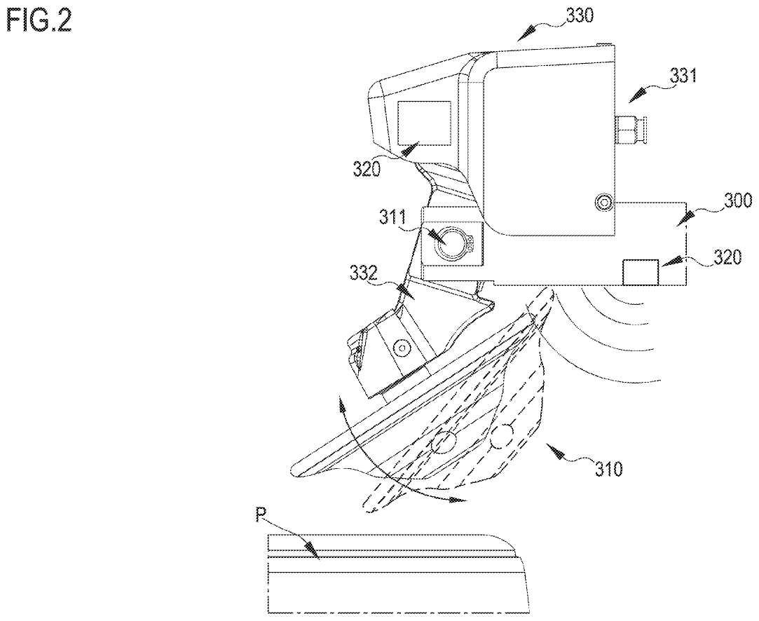

With reference to FIG. 2, the bead breaker disk 310 mounted idle on the support arm 300 is shown before the start of the bead breaking operation, in the two positions, retracted/advanced with respect to the axis of rotation A of the wheel.

During the bead breaking operation, the bead breaker disk 310 is positioned, by an operator by means of a handle (not shown) or at least partially or completely automatically, by the use of actuators, in the vicinity of the tire P and substantially at the upper edge C1 of the rim, without however generally touching it. This movement of the bead breaker tool generally is performed by moving the support arm or a component thereof both in a direction substantially parallel to the axis of rotation of the wheel, and in a direction substantially perpendicular to this axis of rotation.

Optionally, the support arm which supports the bead breaker tool may also be rotated about the longitudinal axis L of the upright 210, in a plane substantially parallel to the support surface of the base 100 of the tire changer.

The bead breaker disk 310 is mounted pivotably on the support arm 300 by means of a bracket 332 hinged with the pivot pin 311 of the support arm 300.

In the embodiment shown in FIG. 2, the sensor 320 is mounted on the support arm 300 of the bead breaker disk 310 and comprises a scanning radar system, preferably a millimeter-wave (or mmWave) radar system.

The term millimeter-wave refers to the spectrum of radio waves with frequencies between 30 and 300 GHz, or with a wavelength ranging between 1 and 10 millimeters.

Preferably, the radar system of the present invention operates at frequencies between 76 and 81 GHz, corresponding to a wavelength of around 4 mm.

A complete mmWave radar system comprises radiofrequency (RF) transmitter (Tx) and receiver (Rx) components, analog components, such as a clock oscillator and digital components, such as analog/digital convertors (ADC), microcontrollers (MCU) and digital signal processors (DSP).

These components, including the antenna, may be miniaturized and incorporated in a single chip, and are available from a number of manufacturers; for example see the families of mmWave sensors under the names IWRx and AWRx supplied by the company Texas Instruments Incorporated. Such a radar system may be incorporated in at least one, or more, contactless sensor devices. By virtue of the millimeter-wave propagation characteristics, the contactless sensor devices of the present invention use the electromagnetic waves reflected by objects in their path to determine the position, speed and distance of those objects.

The contactless sensor device 320 can thus detect a distance between a reference point, for example integral with said sensor, and at least one point belonging to the wheel to be maintained. Since the dimensions of the bead breaker disk 310 are known, as are the distance and/or the relative positions between the contactless sensor device 320 and the bead breaker disk 310, it is thus possible to accurately determine the distance between the bead breaker disk 310 and the wheel.

The sensor device 320 is in general able to acquire the distances relating to a plurality of points of the wheel, belonging for example to an outer contour of the rim of the wheel and/or belonging to the tire of the wheel, preferably belonging to the sidewall of the tire of the wheel.

Thus, the actuators (known per se and not shown in detail) with which the tire changer is equipped can control, with accuracy, the support arm 300 at least in an area of space close to the wheel.

In the present detailed description, reference is frequently made to the pivoting of the tool; the contactless sensor device 320 can therefore provide, to a control unit 400, information useful for controlling the actuation of said pivoting. However, in general, the scanning data supplied by the contactless sensor device 320 may be used to control the actuation of any other movement of the tools with which the tire changer is provided, both in the case where said tools are pivoting and in the case where they are not.

The actuators, for example those assigned to the movement of the support arm 300 in the direction of the longitudinal axis L of the upright 210 or in a direction substantially perpendicular to the direction of the longitudinal axis L of the upright 210, are generally provided with sensor means, for example potentiometers, pressure sensors, etc., that can determine the position in said directions of the support arm 300 relative to the upright 210.

Such sensor means, together with the contactless sensor device 320, are operationally connected to the control unit 400, which can control the abovementioned actuators.

The contactless sensor device 320 can also detect when the distance between the bead breaker disk 310 and the wheel is such that it is appropriate to command pivoting thereof.

Alternatively or in addition, the pivoting command may be sent when the contactless sensor device 320 detects rotation of the wheel.

In any case, the contactless sensor device 320 will send an appropriate signal to the control unit 400 of the tire changer 1, which will activate the tire actuator 330 which, by means of a shaft 331 (shown partially in the figure), will pivot the bracket 332 about the pivot pin 311, causing it to rotate clockwise.

Thus, the bead breaker disk 310 will be oscillated clockwise, reaching a second position which, with respect to the previous position, is closer to the axis of rotation A of the wheel R.

In this second position, the bead breaker disk 310 can be inserted under the edge C1 of the rim and effectively place pressure on the sidewall of the tire, thereby separating the bead of the tire from the rim, as the wheel R is rotated by the support 110.

Often, in this step, the support arm 300 of the tool 310 is also duly moved, by means of suitable actuators, in a direction substantially parallel to the axis of rotation A of the wheel, toward the wheel, so as to exert greater pressure on the tire and facilitate the separation of the bead from the rim.

Using the data on the distance between the tool and the wheel supplied by the contactless sensor device 320, the control unit 400 can automatically and accurately control said actuators during at least part of the bead breaking process.

In this step, in general, the bead breaker disk can come into contact both with the tire and with the rim.

Once the bead breaking operation is complete, the bead breaker tool 310 will be moved away from the wheel, and the bead breaker disk will return to its initial position retracted from the axis of rotation A of the wheel R.

The contactless sensor device 320 with which the support arm 300 of the bead breaker disk 310 is provided, can accurately acquire data relating to the geometry of the wheel to be handled. Such data may be shared and used by the tire changer to control other tools with which it is provided, and/or may be saved, at least temporarily, on memory means both locally and remotely (for example, on a cloud), accessible to the control unit 400.

Using these data, the tire changer of the present invention, and possibly other tire changers connected on a network, may, by means of suitable machine learning and/or artificial intelligence algorithms, be trained to handle the wheel to be maintained with increasing speed, efficiency and accuracy.

The pivoting command sent by the control unit 400 to the tire actuator 330 may be sent either when the sensor 320 detects contact (or the reaching of a predetermined suitable distance) between the wheel and the tool, irrespective of any other conditions, or as a function of other conditions being fulfilled, in addition to the detection of said predetermined distance or contact between the wheel and the tool.

For example, in one possible embodiment, the control unit is designed to send the pivoting command only if it is verified that the wheel is, at the same time, placed in rotation. Such verification may be performed by the control unit in various ways, for example by monitoring the power consumed by an electric motor (known per se and not shown in the figures) used to rotate the support 110, or by detecting rotation of the support 110 directly, for example using an encoder, or by means of optical sensors or other types of sensors, and even possibly using the scanning data supplied by said contactless sensor device 320 (or by another similar contactless sensor device) which can not only detect distance but also position (for example inclination) and speed of the objects scanned.

In another embodiment, the control unit sends the pivoting command only if it is verified that the tool is in the correct position, established for example by the manufacturer of the tire changer or by the operator, relative to the wheel. This monitoring of the position of the tool may for example be performed through the use of potentiometric sensors associated with the support arm 300 or with the arm-piece 303, and/or through the use of optical sensors that can detect the position of the edge of the tire, or possibly through the use of another contactless sensor device, comprising a radar system according to the invention, or possibly even through the use of the same contactless sensor device 320 already included in the tire changer.

The above description relating to the bead breaker tool 310 may be likewise applied also to other tools with which the tire changer is provided, for example the contactless sensor device 320 comprising a radar system may also be mounted on the mounting/demounting tool 700 and/or on the auxiliary tool 800 and/or on the further pivoting tool 604. It is also possible to include a contactless sensor device comprising a radar system according to the invention possibly also in the base 100 and/or the frame 200 and/or the upright 210 of the tire changer.

The tire changer may therefore have one or more contactless sensor devices comprising a radar system, mounted in different positions. Such contactless sensor devices may be mounted in fixed positions or on moving components (for example on the tools or on the respective support elements), and the position, distance and speed data detected thereby may be assessed with respect to both fixed reference positions and movable reference positions.

### LIST OF REFERENCES

1 tire changer
R wheel
P tire
C rim
C1 first edge of the rim C
C2 second edge of the rim C
100 base
110 support for receiving and rotating the wheel R
A axis of rotation of the wheel R
200 frame
210 upright
L longitudinal axis of the upright 210
300 (first) support arm
301 first element of the (first) support arm
302 second element of the (first) support arm
303 arm-piece of the (first) support arm
X longitudinal axis of the (first) support arm
310 (first) bead breaker disk
311 pivot pin
320 contactless sensor device
330 actuator for pivoting the (first) bead breaker disk
332 bracket
331 shaft
400 control unit
600 (second) support arm
601 first element of the (second) support arm
602 second element of the (second) support arm
603 arm-piece of the (second) support arm
610 (second) bead breaker disk
604 further pivoting tool
Y longitudinal axis of the (second) support arm
700 mounting/demounting tool
800 auxiliary tool

1. A method for demounting a tire (P) from a rim (C) of a vehicle wheel (R) or for mounting a tire (P) on a rim of a vehicle wheel, comprising the steps of
securing the rim (C) of the wheel (R) to a rotary support element (110);
detecting a distance, with respect to a reference position, of at least one point belonging to the wheel (R) by means of at least one contactless sensor device (320); detecting the position of at least one mounting and/or demounting tool (310; 610; 700; 800; 604) relative to the reference position;
correlating the position of the at least one mounting and/or demounting tool with the distance of the at least one point belonging to the wheel, relative to the reference position;
moving, during the operation of mounting the tire (P) on the rim (C) and/or demounting the tire (P) from the rim (C), the at least one mounting and/or demounting tool (310; 610; 700; 800; 604) as a function of the distance of the at least one point belonging to the wheel with respect to the reference position;
characterized in that the at least one contactless sensor device (320) comprises a radar system.

2. The method as claimed in claim 1, wherein the radar system operates at frequencies between 300 MHz and 300 GHz.

3. The method as claimed in claim 2, wherein the radar system is a millimeter-wave radar system and operates at frequencies between 30 GHz and 300 GHz, preferably between 76 GHz and 81 GHz.

4. The method as claimed in claim 1, wherein the at least one contactless sensor device (320) can detect the distance, with respect to the reference position, of a plurality of points belonging to the wheel.

5. The method as claimed in claim 4, wherein the at least one contactless sensor device (320) can detect the distance, with respect to the reference position, of an outer contour of the rim of the wheel.

6. The method as claimed in claim 1, wherein the at least one contactless sensor device (320) can detect the distance, with respect to the reference position, of at least one point belonging to the tire of the wheel, preferably belonging to the sidewall of the tire of the wheel.

7. An apparatus (1) for demounting a tire (P) from a rim (C) of a vehicle wheel (R) or for mounting a tire (P) on a rim (C) of a vehicle wheel (R), comprising:
a rotary support element (110) to which the rim (C) of the wheel (R) is reversibly secured;
motor means for rotating the rotary support element (110);
at least one mounting and/or demounting tool (310; 610; 700; 800; 604) for mounting the tire on the rim and/or for demounting the tire from the rim;
at least one contactless sensor device (320), for detecting a distance, with respect to a reference position, of at least one point belonging to the wheel;
sensor means for detecting the position of the at least one mounting and/or demounting tool (310; 610; 700; 800; 604) relative to the reference position;
a control unit (400) for correlating the position of the at least one mounting and/or demounting tool (310; 610; 700; 800; 604) with the distance of the at least one point belonging to the wheel, relative to the reference position;
at least one actuator, guided by the control unit (400), for moving the at least one mounting and/or demounting tool (310; 610; 700; 800; 604) as a function of the distance of the at least one point belonging to the wheel with respect to the reference position;
characterized in that
the at least one sensor device (320) comprises a radar system.

8. The apparatus as claimed in claim 7, wherein the radar system operates at frequencies between 300 MHz and 300 GHz.

9. The apparatus as claimed in claim 8, wherein the radar system is a millimeter-wave radar system and operates at frequencies between 30 GHz and 300 GHz, preferably between 76 GHz and 81 GHz.

10. The apparatus as claimed in claim 7, wherein the at least one contactless sensor device (320) can detect the distance, with respect to the reference position, of a plurality of points belonging to the wheel, preferably belonging to an outer contour of the rim of the wheel.

11. The apparatus as claimed in claim 7, wherein the at least one contactless sensor device (320) can detect the distance, with respect to the reference position, of at least one point belonging to the tire of the wheel, preferably belonging to the sidewall of the tire of the wheel.

12. The apparatus as claimed in claim 7, comprising a plurality of mounting/demounting tools.

13. The apparatus as claimed in claim 12, wherein the plurality of mounting/demounting tools comprises at least one bead breaker tool.

14. The apparatus as claimed in claim 7, wherein the control unit (400) is connected to memory means for storing, at least temporarily, data relating to geometric characteristics of the wheel.

15. The apparatus as claimed in claim 14, wherein the memory means are located on a remote computer system.
